(19) United States
(12) Patent Application Publication
(10) Pub. No.: US 2025/0271967 A1
(43) Pub. Date: Aug. 28, 2025

(54) DISPLAY DEVICE AND METHOD FOR DRIVING THE SAME

(71) Applicant: SAMSUNG DISPLAY CO., LTD., YONGIN-SI (KR)

(72) Inventors: Jun Young KO, Yongin-si (KR); Keum Dong JUNG, Yongin-si (KR)

(21) Appl. No.: 18/985,742

(22) Filed: Dec. 18, 2024

(30) Foreign Application Priority Data
Feb. 26, 2024 (KR) 10-2024-0027114

(51) Int. Cl. G06F 3/041; G06F 3/044; G09G 3/20

(52) U.S. Cl. CPC G06F 3/04184; G06F 3/0446; G09G 3/2092; G09G 2320/0247; G09G 2354/00

(57) ABSTRACT

According to an embodiment, a display device may include a display panel comprising touch driving electrodes, and a touch driver circuit comprising a driving signal output unit configured to output driving signals supplied to the touch driving electrodes, and a touch control unit configured to control the driving signal output unit. The touch driver circuit is configured to sequentially output the driving signals in response to a vertical synchronization signal, receive a detection signal associated with a touch input on the display panel, calculate an elapsed time from a first time when the vertical synchronization signal is output until a second time when the detection signal is received, and determine touch coordinates of the touch input based on the elapsed time.

### CROSS-REFERENCE TO RELATED APPLICATION

This application claims priority under 35 U.S.C. 119 from Korean Patent Application No. 10-2024-0027114, filed on Feb. 26, 2024, in the Korean Intellectual Property Office, the disclosure of which is herein incorporated by reference in its entirety.

### BACKGROUND

### 1. Technical Field

The present disclosure relates to a display device and a method for driving the same.

### 2. Discussion of Related Art

With the advancement of information-oriented societies, increasing demands are being placed on display devices in connection with the manner in which images may be displayed. The display panel of a display device may include a liquid crystal display, a field emission display, or a light emitting display. A light emitting display device may include an organic light emitting display device including an organic light emitting diode element as a light emitting element or a light emitting diode display device including an inorganic light emitting diode element such as a light emitting diode (LED) as a light emitting element.

In some cases, the display panel of a display device may include a touch panel as an input device. A touch driver circuit that drives the touch panel may generate driving signals to drive touch electrodes of the touch panel. These driving signals may result in signal noise that may cause image flicker on the display panel. Further, as the areas of the display panel and touch panel increase, a time to calculate touch coordinates and the power consumption for making the calculation may increase.

### SUMMARY

Aspects of the present disclosure provide a display device that can reduce a calculation time and power consumption of an operation to identify touch coordinates and can suppress a flicker condition of the display panel due to driving of the touch panel, and a method for driving the same.

According to an embodiment of the disclosure, a display device may include a display panel comprising touch driving electrodes, and a touch driver circuit comprising a driving signal output unit configured to output driving signals supplied to the touch driving electrodes, and a touch control unit configured to control the driving signal output unit. The touch driver circuit is configured to sequentially output the driving signals in response to a vertical synchronization signal, receive a detection signal associated with a touch input on the display panel, calculate an elapsed time from a first time when the vertical synchronization signal is output until a second time when the detection signal is received, and determine touch coordinates of the touch input based on the elapsed time.

The display panel may include touch sensing electrodes disposed intersecting with the touch driving electrodes, and the touch driver circuit receives the detection signal through the touch sensing electrodes.

The touch driver circuit is configured to store a plurality of first output times until the driving signals are sequentially output measured from the first time, store a plurality of second output times until horizontal synchronization signals of the display panel are sequentially output measured from the first time, determine a first counting time corresponding to the elapsed time among the plurality of first output times, to determine an x coordinate of the touch coordinates based on the first counting time, and determine a second counting time corresponding to the elapsed time among the plurality of second output times, to determine a y coordinate of the touch coordinates based on the second counting time.

The touch driver circuit transmits the x coordinate and the y coordinate of the touch coordinates to a host of the display device.

The host is a processor.

The touch driving electrodes are self-capacitive touch electrodes arranged in a matrix.

The touch driver circuit stores a plurality of third output times until driving signals are sequentially output measured from the first time, and determines a third counting time corresponding to the elapsed time among the plurality of third output times, to determine an x coordinate and a y coordinate of the touch coordinates based on the third counting time.

According to an embodiment of the disclosure, a display device comprising a host, a display panel comprising touch driving electrodes, and a touch driver circuit comprising a driving signal output unit configured to output driving signals supplied to the touch driving electrodes, and a touch control unit configured to control the driving signal output unit. The touch driver circuit is configured to sequentially output the driving signals in response to a vertical synchronization signal of the display panel, receive a detection signal associated with a touch input on the display panel, and transmit an elapsed time until a second time when the detection signal is received measured from a first time when the vertical synchronization signal is output by the host of the display device, and the host determines touch coordinates of the touch input based on the elapsed time received from the touch driver circuit.

The host is a processor.

The display panel may further include touch sensing electrodes disposed intersecting with the touch driving electrodes, and the touch driver circuit receives the detection signal through the touch sensing electrodes.

The host is configured to store a plurality of first output times until the driving signals are sequentially output measured from the first time, store a plurality of second output times until horizontal synchronization signals of the display panel are sequentially output measured from the first time, determine a first counting time corresponding to an elapsed time among the plurality of first output times, to determine an x coordinate of the touch coordinates based on the first counting time, and determine a second counting time corresponding to an elapsed time among the plurality of second output times, to determine a y coordinate of the touch coordinates based on the second counting time.

The touch driving electrodes are self-capacitive touch electrodes arranged in a matrix.

The host stores a plurality of third output times until driving signals are sequentially output measured from the first time, and determines a third counting time corresponding to an elapsed time among the plurality of third output times, to determine an x coordinate and a y coordinate of the touch coordinates based on the third counting time.

According to an embodiment of the disclosure, a method for driving a display device, wherein the display device may include a display panel that includes touch driving electrodes, and a touch driver circuit configured to output driving signals supplied to the touch driving electrodes, the method may include outputting, sequentially, by the touch driver circuit, the driving signals in response to a vertical synchronization signal of the display panel, receiving, by the touch driver circuit, a detection signal associated with a touch input on the display panel, calculating, by the touch driver circuit, an elapsed time until a second time when the detection signal is received measured from a first time when the vertical synchronization signal is output, and determining, by the touch driver circuit, touch coordinates of the user's touch based on the elapsed time.

The display panel further may include touch sensing electrodes disposed intersecting with the touch driving electrodes, and receiving, by the touch driver circuit, the detection signal through the touch sensing electrodes.

The method may further include storing, by the touch driver circuit, a plurality of first output times until the driving signals are sequentially output measured from the first time, storing, by the touch driver circuit, a plurality of second output times until horizontal synchronization signals of the display panel are sequentially output measured from the first time, determining, by the touch driver circuit, a first counting time corresponding to the elapsed time among the plurality of first output times, to determine an x coordinate of the touch coordinates based on the first counting time, and determining, by the touch driver circuit, a second counting time corresponding to an elapsed time among the plurality of second output times, to determine a y coordinate of the touch coordinates based on the second counting time.

The method may further include transmitting, by the touch driver circuit, the x coordinate and the y coordinate of the touch coordinates to a host of the display device.

The host is a processor.

The touch driving electrodes are self-capacitive touch electrodes arranged in a matrix, wherein the method may further include storing, by the touch driver circuit, a plurality of third output times until driving signals are sequentially output measured from the first time, and determining, by the touch driver circuit, a third counting time corresponding to the calculated elapsed time among the plurality of third output times, to determine the x coordinate and the y coordinate of the touch coordinates based on the third counting time.

The method may further include receiving the touch input on the display panel prior to the first time.

According to the embodiments of the present disclosure, a calculation time and power consumption of an operation to identify touch coordinates in a display device can be reduced, and a flicker condition of the display panel due to driving of a touch panel can be suppressed.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a perspective view of a display device according to an exemplary embodiment of the present disclosure.

FIG. 2 is a cross-sectional view of a display device according to an embodiment of the present disclosure.

FIG. 3 is a view conceptually showing a display unit and a touch driver according to an exemplary embodiment of the present disclosure.

FIG. 4 is a plan view showing a display unit of a display device according to an exemplary embodiment of the present disclosure.

FIG. 5 is a plan view showing a touch unit of a display device according to an exemplary embodiment of the present disclosure.

FIG. 6 is an enlarged view of area A1 of FIG. 5.

FIG. 7 is an enlarged view showing a part of a display device according to an embodiment of the present disclosure.

FIG. 8 is a cross-sectional view of a display device according to an exemplary embodiment of the present disclosure, taken along line I-I′ of FIG. 7.

FIG. 9 is a block diagram showing a touch unit and a touch driver according to an embodiment of the present disclosure.

FIG. 10 is a plan view schematically showing a touch unit by self-capacitance sensing.

FIG. 11 is a flowchart illustrating operation of a display device according to an embodiment of the present disclosure.

FIG. 12 is a view for illustrating a method for identifying a touch in a display device according to an embodiment of the present disclosure.

FIG. 13 is a view for illustrating driving timing of a display device according to an embodiment.

FIG. 14 is a flowchart illustrating a method for identifying touch coordinates using the touch unit shown in FIGS. 5 to 9.

FIG. 15 is a flowchart illustrating a method for identifying touch coordinates using the touch unit shown in FIG. 10.

### DETAILED DESCRIPTION

The present invention will now be described more fully hereinafter with reference to the accompanying drawings, in which preferred embodiments of the invention are shown. Aspects of the present invention may, however, be embodied in different forms and should not be construed as limited to embodiments set forth herein. Rather, embodiments are provided so that this disclosure will be thorough and complete, and will filly convey the scope of the invention to those skilled in the art.

It will also be understood that when a layer is referred to as being “on” another layer or substrate, the layer can be directly on the other layer or substrate, or intervening layers may also be present. In contrast, when an element is referred to as being “directly on” another element, there may be no intervening elements present. The same reference numbers indicate the same components throughout the specification.

It will be understood that, although the terms “first,” “second,” etc. may be used herein to describe various elements, these elements should not be limited by these terms. These terms are only used to distinguish one element from another element. For example, a first element could be termed a second element without departing from the teachings of the present invention. Similarly, the second element could be termed the first element.

Features of each of various embodiments of the present disclosure may be partially or entirely combined with each other and may cooperate with each other in various ways, and respective embodiments may be implemented independently of each other or may be implemented together in association with each other.

Hereinafter, embodiments will be described with reference to the accompanying drawings.

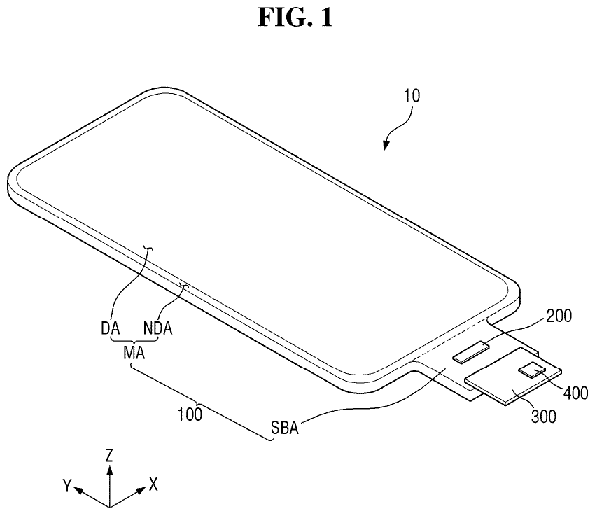

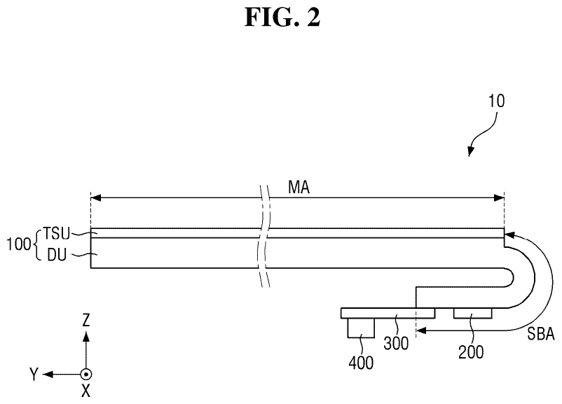

FIG. 1 is a plan view of a display device according to an embodiment of the present disclosure. FIG. 2 is a cross-sectional view of the display device according to an embodiment of the present disclosure.

According to an embodiment of the present disclosure, the display device 10 may have a rectangular shape when viewed from above. In the drawings, a first direction X and a second direction Y may intersect each other as the horizontal directions. In addition, a third direction Z may intersect the first direction X and the second direction Y, and may be a vertical direction. For example, the first direction X may refer to a direction parallel to a first side of the display device 10 when viewed from above. The second direction Y may refer to a direction parallel to a second side of the display device 10 that meets the first side when viewed from above. The third direction Z may refer to a thickness direction of the display device 10. It should be understood that the directions referred to herein are relative directions used for clearly describing aspects of the present disclosure, and are not to be considered limiting.

The display device 10 may be any of a variety of electronic devices that provide a display screen. For example, the display device 10 may be employed by portable electronic devices such as a mobile phone, a smart phone, a tablet PC, a mobile communications terminal, an electronic notebook, an electronic book, a portable multimedia player (PMP), a navigation device, or a ultra mobile PC (UMPC). For example, the display device 10 may be used as a display unit DU of a television, a laptop computer, a monitor, an electronic billboard, or an Internet of Things (IoT) device. In addition, the display device 10 may be used as a display unit DU of wearable devices such as a smart watch, a watch phone, a glasses-type display, or a head-mounted display (HMD) device.

Referring to FIG. 1, the display device 10 may have a substantially rectangular shape when viewed from above. For example, the display device 10 may have a shape similar to a quadrangle having shorter sides in the first direction X and longer sides in the second direction Y when viewed from above. The corners where the sides in the first direction X meet the sides in the second direction Y may be rounded with a predetermined curvature or may be formed as right angles. The shape of the display device 10 is not limited to a rectangular shape, and may have a shape similar to other polygonal shapes, a circular shape, or an elliptical shape.

At least one of a front surface and a rear surface of the display device 10 may be a display surface. As used herein, the front surface may refer to a surface located on a side of a plane, e.g., the surface located on the side indicated by the arrow of the third direction Z in the drawings. The rear surface refers to the surface located on an opposite side of the plane from the front surface, e.g., the surface located on the opposite side to the side indicated by the arrow of the third direction Z in the drawings. The display device 10 may be a double-sided display device 10 in which images can be displayed on one or more of the front and rear surfaces. In the following description, the display surface may be located on the front side of the display device 10 according to an exemplary embodiment.

The display device 10 may include a display panel 100 providing a display screen, a display driver circuit 200, a circuit board 300, and a touch driver circuit 400. The touch driver circuit 400 may be an element configured to sense a touch input (e.g., a user's touch input) and may be referred to as a “touch detection device.”

The display panel 100 may have a substantially rectangular shape when viewed from above. For example, the display panel 100 may have a shape similar to a quadrangle having shorter sides in the first direction X and longer sides in the second direction Y when viewed from above. The corners where the sides in the first direction X meet the sides in the second direction Y may be rounded with a predetermined curvature or may be formed as right angles. The shape of the display panel 100 is not limited to a rectangular shape, and may have a shape similar to other polygonal shapes, a circular shape, or an elliptical shape. In addition, the display panel 100 may be formed to be flexible so that it can be curved or bent.

The display panel 100 may include a main area MA and a subsidiary area SBA.

The main area MA may include a display area DA and a non-display area NDA. The display area may include pixels for displaying images. The non-display area NDA may be located adjacent to the display area DA. For example, the non-display area NDA may surround the display area DA. The display area DA may output light from a plurality of emission areas or a plurality of open areas. For example, the display panel 100 may include a pixel circuit including switching elements, a pixel-defining layer that defines the emission areas or the opening areas, and a self-light-emitting element.

The non-display area NDA may be located on a periphery of the display area DA. The non-display area NDA may define an edge of the main area MA of the display panel 100. The non-display area NDA may include a gate driver (not shown) supplying gate signals to gate lines (not shown) of the display panel 100.

The subsidiary area SBA may extend from a side of the main area MA. The subsidiary area SBA may be bent such that at least a portion of the subsidiary area SBA overlaps with the main area MA in the third direction Z. The subsidiary area SBA may include a pad area. The display driver circuit 200 and the circuit board 300 may be electrically connected to the display panel 100 at the pad area of the subsidiary area SBA.

Referring to FIG. 2, the display panel 100 may include a display unit DU and a touch unit TSU.

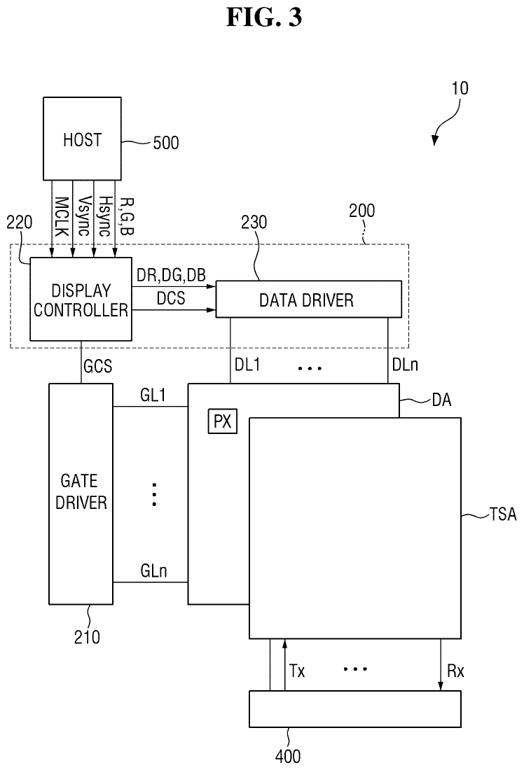

The display unit DU may include a plurality of pixels PX (see FIG. 3). Each of the pixels PX may be a unit for generating light. Each pixel PX may include, but is not limited to, a red sub-pixel, a green sub-pixel, and a blue sub-pixel. For example, each pixel PX may include, but is not limited to, a red sub-pixel, two green sub-pixels, and a blue sub-pixel. The plurality of pixels PX may be arranged to be viewed from above. For example, the pixels PX may be arranged in, but is not limited to, a matrix. The plurality of pixels PX may generate light and display an image.

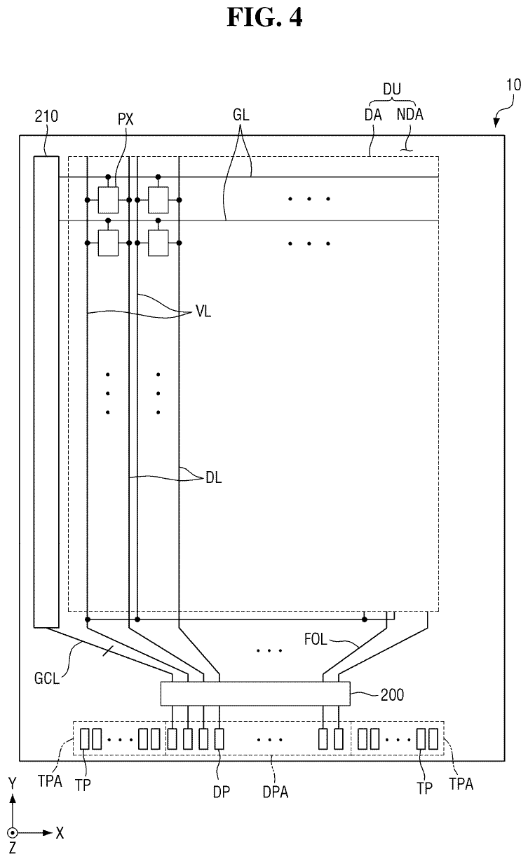

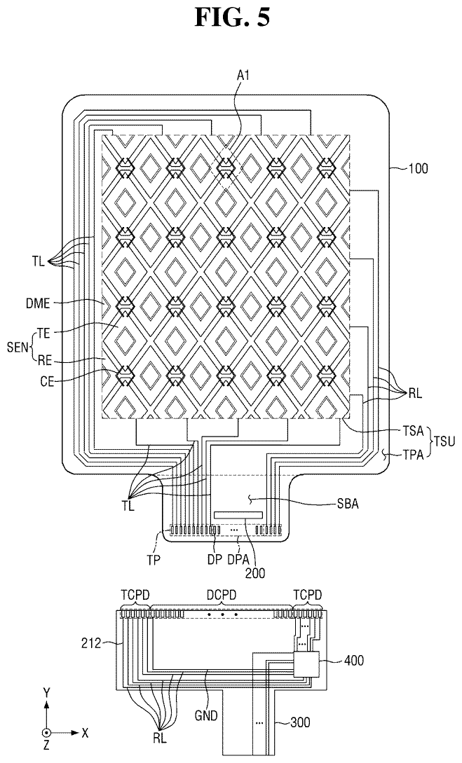

The touch unit TSU may be disposed on the display unit DU. However, the present disclosure is not limited thereto. For example, the touch unit TSU may be formed together with the display unit DU using an in-cell touch technology. The touch unit TSU may include a plurality of touch electrodes SEN, a plurality of touch driving lines TL, and a plurality of touch sensing lines RL (see FIG. 5). The plurality of touch electrodes SEN may be used for detecting a touch input (e.g., a user's touch or a pen touch) by capacitive sensing. The plurality of touch driving lines TL and the plurality of touch sensing lines RL may connect the plurality of touch electrodes SEN with the touch driver circuit 400. The touch unit TSU may be a layer that detects a touch input and may be referred to as a touch member. The touch unit TSU may determine whether there is a touch input and may calculate touch input coordinates of a position of the touch input, if any. The display unit DU and the touch unit TSU will be described in detail with reference to FIGS. 4 to 7.

The display unit DU and the touch unit TSU may overlap each other. For example, the display area DA may be an area for displaying images on the screen and for detecting a touch input.

The subsidiary area SBA of the display panel 100 may be disposed at a side of the main area MA. For example, the subsidiary area SBA of the display panel 100 may extend from a side of the main area MA. The subsidiary area SUB may include a flexible material that can be bent, folded, or rolled. For example, a portion of the subsidiary area SBA may be bent at a side of the main area MA, and at least a portion of the subsidiary area SBA extended from the bent portion of the subsidiary area SBA may overlap with the main area MA in the third direction Z (e.g., a z-axis direction). For example, at least a portion of the subsidiary area SBA may be disposed below the main area MA in a direction opposite to the third direction Z. The subsidiary area SBA may include pads (not shown) electrically connected to the display driver circuit 200 and the circuit board 300.

Referring to FIG. 1, the display driver circuit 200 may be disposed in the subsidiary area SBA of the display panel 100. In addition, the display driver circuit 200 may be implemented as an integrated circuit (IC). The display driver circuit 200 may be mounted on the display panel 100 by the chip-on-glass (COG) technique or the chip-on-plastic (COP) technique, for example.

The display driver circuit 200 may output data signals and voltages for driving the display panel 100. The display driver circuit 200 may supply data voltages to data lines (not shown) of the display panel 100. The display driver circuit 200 may provide supply voltages to voltage lines of the display panel 100 and may provide gate control signals to the gate driver.

The circuit board 300 may be disposed in the subsidiary area SBA of the display panel 100. Lead lines (not shown) of the circuit board 300 may be electrically connected to the pad area of the display panel 100. The circuit board 300 may be a flexible printed circuit board, a printed circuit board, or a flexible film such as a chip-on film.

The circuit board 300 may include a plurality of conductive layers (not shown) that may transmit a signal from a circuit board (not shown) to the display driver circuit 200. The plurality of conductive layers of the circuit board 300 may electrically connect the touch driver circuit 400 with a plurality of first electrodes TE and a plurality of second electrodes RE of the touch unit TSU.

Herein, the first electrodes TE may be interchangeably used with the term “touch driving electrodes.” Herein, the second electrodes RE may be interchangeably used with the term “touch sensing electrodes.”

The touch driver circuit 400 may be disposed in the subsidiary area SBA of the display panel 100. In an embodiment, the touch driver circuit 400 may be mounted on the circuit board 300 in the subsidiary area SBA of the display panel 100.

The touch driver circuit 400 may sense a change in the capacitance between the touch electrodes. The touch driver circuit 400 may detect a touch input and may find the coordinates of the touch input, if any, based on a change in the capacitance between the touch electrodes. For example, the touch driver circuit 400 may detect a touch input and may find the coordinates of the touch input, if any, by sensing an amount of a change in the capacitance between the touch electrodes. The touch driver circuit 400 may be implemented as an integrated circuit (IC). The touch driver circuit 400 may be mounted on the display panel 100 by the chip-on-glass (COG) technique or the chip-on-plastic (COP) technique. However, the present disclosure is not limited thereto, and the touch driver circuit 400 may be mounted by any of a variety of techniques.

FIG. 3 is a view conceptually showing a display unit and a touch driver according to an exemplary embodiment of the present disclosure. FIG. 4 is a plan view showing a display unit of a display device according to an exemplary embodiment of the present disclosure.

Referring to FIGS. 3 and 4, the display device 10 may include the display panel 100 (see FIG. 2) including a plurality of pixels PX, the display driver circuit 200, and the touch driver circuit 400. The display driver circuit 200 and the touch driver circuit 400 may operate based on a control signal or a command signal received from a host 500 of the display device 10. For example, the host 500 may be a processor. According to an embodiment, the touch driver circuit 400 may be controlled by the display driver circuit 200.

The display driver circuit 200 may include a data driver 230 and a display controller 220.

The display controller 220 may receive input data R, G, and B and timing control signals from an external source (e.g., the host 500). The timing control signals may include a vertical synchronization signal Vsync, a horizontal synchronization signal Hsync, and a main clock MCLK. The vertical synchronization signal Vsync may indicate a frame period for display of an image. The horizontal synchronization signal Hsync may indicate a horizontal period for display of an image. The main clock MCLK may be repeated at a predetermined cycle. The input data R, G, and B may be RGB data including red image data, green image data, and blue image data. The display controller 220 may generate output data signals DR, DG, and DB and internal control signals using the input data R, G, and B and the timing control signal. The internal control signals may include a data control signal DCS and a gate control signal GCS.

The display controller 220 may control the operation of the data driver 230 by providing the data control signal DCS to the data driver 230. The display controller 220 may control the operation of the gate driver 210 by providing the gate control signal GCS to the gate driver 210.

The data driver 230 may receive the output data signals DR, DG, and DB, and the data control signal DCS from the display controller 220. The data driver 230 may generate a data signal using the output data signals DR, DG, and DB, and the data control signal DCS. The data driver 230 may provide the generated data signal to the display unit DU of the display panel 100 (see FIG. 2). The data driver 230 may provide data signals to the plurality of pixels PX through a plurality of data lines DL1 to DLn (see FIG. 4) formed in the display panel 100.

The gate driver 210 may receive the gate control signal GCS from the display controller 220. The gate driver 210 may generate a gate signal using the received gate control signal GCS. The gate driver 210 may provide the generated gate signal to the display panel 100. The gate driver 210 may provide gate signals to the plurality of pixels PX through a plurality of gate lines GL1 to GLn (e.g., lines GL of FIG. 4) formed in the display panel 100. The plurality of data lines DL1 to DLn and the plurality of gate lines GL1 to GLn will be described in detail with reference to FIG. 4.

Although FIG. 3 illustrates that the gate driver 210 may be disposed apart from the display driver circuit 200, the present disclosure is not limited thereto. For example, the gate driver 210 may be included in the display driver circuit 200. For example, the gate driver 210, the data driver 230, and the display controller 220 may be implemented as integrated circuits (ICs). The gate driver 210 may be formed together during a process of fabricating thin-film transistors of the display panel 100. The display controller 220 and the data driver 230 may be merged to form a timing controller embedded driver (TED) integrated circuit.

The display unit DU of the display panel 100 may include a plurality of pixels PX connected to the plurality of data lines DL (see FIG. 4) and the plurality of gate lines GL (see FIG. 4).

A frame frequency at which the display driver circuit 200 drives the display panel 100 may be variable. For example, the frame frequency may vary within the range of about 1 Hz to 240 Hz. The frame frequency may vary pursuant to the host 500. The frame frequency may vary pursuant to a user's selection. The display driver circuit 200 may drive the display panel 100 at about 60 Hz for a period and may change the frame frequency to about 120 Hz for another period pursuant to a user's needs.

The touch unit TSU (see FIG. 2) may have a touch sensing area TSA. The touch sensing area TSA may include the first electrodes TE, the second electrodes RE, the touch driving lines TL, and the touch sensing lines RL (see FIG. 5). The touch sensing area TSA may detect a touch input by receiving an electrical signal Tx from the touch driver circuit 400 disposed on the circuit board 300 through the touch driving lines TL or by sending an electrical signal Rx sensed from the second electrodes RE to the touch driver circuit 400 through the touch sensing lines RL. Specifically, the touch driver circuit 400 may detect a touch input by converting an analog electrical signal Rx detected by the touch sensing area TSA into a digital signal. The touch driver circuit 400 will be described in detail with reference to FIG. 5.

Referring to FIG. 4, the display unit DU may include the display area DA and the non-display area NDA. The display unit DU may include a plurality of sub-pixels PX, a plurality of gate lines GL, and a plurality of data lines DL. The plurality of gate lines GL and the plurality of data lines DL may be connected to the plurality of sub-pixels PX.

The plurality of gate lines GL may supply the gate signals received from the gate driver 210 to the plurality of sub-pixels PX. The plurality of gate lines GL may extend in the first direction X and may be spaced apart from one another in the second direction Y intersecting the first direction X.

The plurality of data lines DL may supply the output data signals DR, DG and DB and the data signals received from the display driver circuit 200 to the plurality of sub-pixels PX. The data lines DL may extend in the second direction Y and may be spaced apart from one another in the first direction X.

The non-display area NDA may surround the display area DA. The non-display area NDA may include the gate driver 210 for applying gate signals to the plurality of scan lines SL, fan-out lines FOL for connecting the plurality of data lines DL with the display driver circuit 200, and display pads DP connected to circuit board 300.

The display driver circuit 200 may supply the gate control signal GCS to the gate driver 210 through a gate control line GCL. The gate driver 210 may generate a plurality of gate signals based on the gate control signal GCS. The gate driver 210 may sequentially supply the plurality of gate signals to the plurality of gate lines GL in a predetermined order.

The display driver circuit 200 may supply a first supply voltage to a first voltage line VL and a second supply voltage to a second voltage line (not shown) through the data driver 230 (see FIG. 3). Each of the plurality of sub-pixels PX may receive the first supply voltage through the first voltage line VL and may receive the second supply voltage through the second voltage line. The first supply voltage may be a predetermined high-level voltage, and the second supply voltage may be a voltage lower than the first supply voltage.

The display pad area DPA and the touch peripheral area TPA may be disposed at an edge of the display panel 100. The display pad area DPA may include a plurality of display pads DP. The plurality of display pads DP may be connected to a processor (e.g., host 500, see FIG. 3) through the circuit board 300. The plurality of display pads DP may be connected to the circuit board 300 to receive digital image data and may supply the digital image data to the display driver circuit 200.

FIG. 5 is a plan view showing a touch unit of a display device according to an exemplary embodiment of the present disclosure.

Referring to FIG. 5, the touch unit TSU may include the touch sensing area TSA and a touch peripheral area TPA. The touch sensing area TSA may sense a user's touch. The touch peripheral area TPA may be disposed around the touch sensing area TSA. The touch sensing area TSA may overlap with at least a portion of the display area DA of the display panel 100, and the touch peripheral area TPA may overlap with at least a portion of the non-display area NDA of the display panel 100.

The touch unit TSU may include a plurality of first electrodes TE, a plurality of second electrodes RE, a plurality of touch driving lines TL, and a plurality of touch sensing lines RL.

The circuit board 300 may include first circuit pads DCPD, second circuit pads TCPD, and touch circuit lines 212. The first circuit pads DCPD may be connected to the display pads DP of the display panel 100. The second circuit pads TCPD may be connected to the touch pads TP of the display panel 100. The touch circuit lines 212 may connect the second circuit pads TCPD with the touch driver circuit 400.

The touch sensing area TSA may include the plurality of first electrodes TE and the plurality of second electrodes RE. The plurality of first electrodes TE and the plurality of second electrodes RE may form the touch electrodes SEN. The plurality of first electrodes TE and the plurality of second electrodes RE may be electrically connected to the touch driver circuit 400 of the circuit board 300. The touch sensing area TSA may receive an electrical signal from the touch driver circuit 400 disposed on the circuit board 300 through the touch driving lines TL and the touch sensing lines RL or may send an electrical signal sensed from the first electrodes TE and the second electrodes RE to the touch driver circuit 400 through the touch driving lines TL and the touch sensing lines RL.

The first electrodes TE may be arranged in the first direction X and in the second direction Y. The first electrodes TE may be spaced apart from one another in the first direction X and in the second direction Y. The first electrodes TE adjacent to one another in the second direction Y may be electrically connected through bridge electrodes CE.

The plurality of first electrodes TE may be connected to the touch pads TP through the touch driving lines TL. Some of the touch driving lines TL may pass a lower side of the touch peripheral area TPA and may be extended to the touch pads TP in the subsidiary area SBA. Some others of the touch driving lines TL may pass an upper side, a left side, and the lower side of the touch peripheral area TPA and may be extended to the touch pads TP in the subsidiary area SBA. The touch pads TP may be connected to the touch driver circuit 400 through the circuit board 300.

The display pad area DPA and the touch pads TP may be disposed at an edge of the subsidiary area SBA of the display panel 100. The display pad area DPA and the touch pads TP may be electrically connected to the circuit board 300 by using a material such as an anisotropic conductive film having a low resistance and high reliability.

The second electrodes RE may extend in the first direction X and may be spaced apart from one another in the second direction Y. The second electrodes RE may be arranged in the first direction X and the second direction Y, and the second electrodes RE adjacent to one another in the first direction X may be electrically connected through connecting portions.

The second electrodes RE may be connected to the touch pads TP through the touch sensing lines RL. For example, the plurality of second electrodes RE disposed on a right side of the touch sensing area TSA may be connected to the touch pads TP through a plurality of touch sensing lines RL. The touch sensing lines RL may extend to the touch pads TP via the right side and the lower side of the touch peripheral area TPA. The touch pads TP may be connected to the touch driver circuit 400 through the circuit board 300.

The first electrodes TE and the second electrodes RE may include a planar pattern formed of a transparent conductive layer or may include a mesh pattern employing an opaque metal along regions where the light-emitting elements are absent. For example, the first electrodes TE and the second electrodes RE may not hinder the progress of light emitted from the display area DA. For example, the first electrodes TE and the second electrodes RE may not reduce a transmittance of light emitted from the display area DA.

A driving signal may be applied from the touch driver circuit 400 to each of the plurality of first electrodes TE through one of the plurality of touch driving lines TL. When a driving signal is applied to the plurality of first electrodes TE, mutual capacitance may be formed between adjacent first electrodes TE and sensing electrodes RE. When there is a touch input, the mutual capacitance between adjacent first electrodes TE and second electrodes RE may be changed. A change in mutual capacitance between adjacent driving electrodes TE and sensing electrodes RE may be transferred to the touch driver circuit 400 through the plurality of touch sensing lines RL. The touch input may be sensed by mutual capacitance sensing, but the present disclosure is not limited thereto.

The touch driver circuit 400 may identify touch coordinates based a time when a change in the mutual capacitance between the first electrodes TE and the second electrodes RE is sensed. For example, the touch driver circuit 400 may calculate an elapsed time from a first time when a vertical synchronization signal for touch sensing is output to a subsequent time when the change in the capacitance is sensed, that is, a second time when the detection signal is received, and may identify touch coordinates based on the calculated elapsed time.

The touch driver circuit 400 may transmit to the host 500, e.g., a processor, the time when the change in the mutual capacitance between the first electrodes TE and the second electrodes RE is sensed. The host 500 may calculate the elapsed time from a first time when the vertical synchronization signal for touch sensing is output to the subsequent time when the change in the capacitance is sensed, that is, a second time when the detection signal is received, and may identify touch coordinates based on the elapsed time.

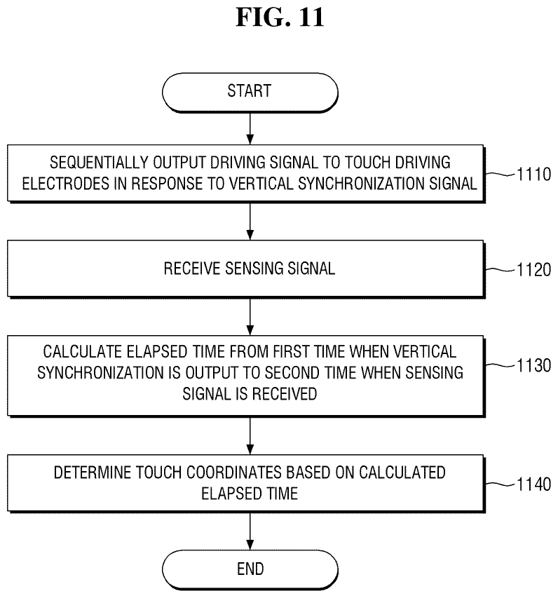

A method for identifying touch coordinates by the touch driver circuit 400 or a processor based on the elapsed time will be described in detail with reference to FIGS. 11 to 14.

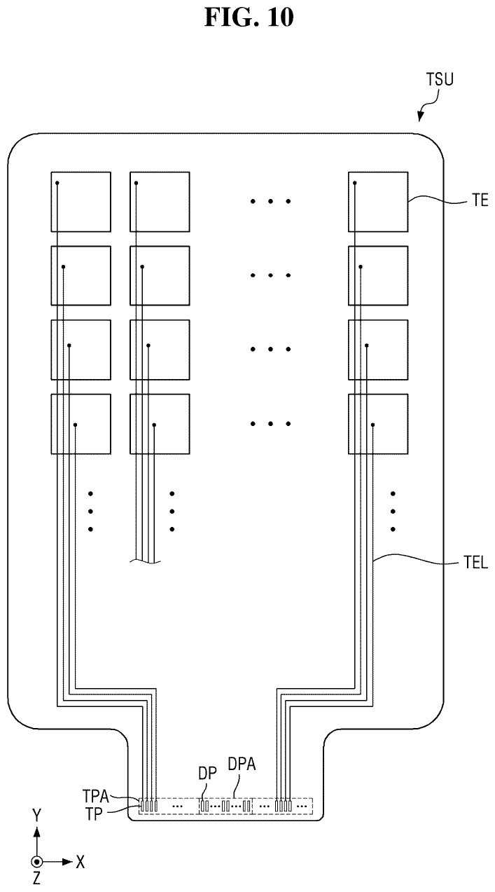

Although a touch may be detected by sensing a change in the mutual capacitance between the first electrodes TE and the second electrodes RE herein, the present disclosure is not limited thereto. For example, the touch unit TSU according to an embodiment of the present disclosure may detect a touch by self-capacitance sensing, as will be described with reference to FIG. 10.

In FIG. 5, a ground line GND may be formed on the circuit board 300.

The display panel 100 may include a plurality of dummy electrodes DME. The plurality of first electrodes TE, the plurality of second electrodes RE, and the plurality of dummy electrodes DME may be disposed in a same layer and may be spaced apart from one another.

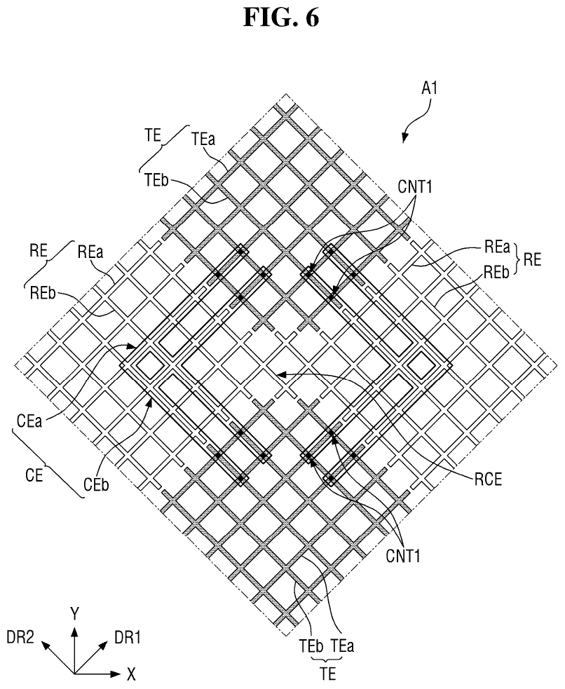

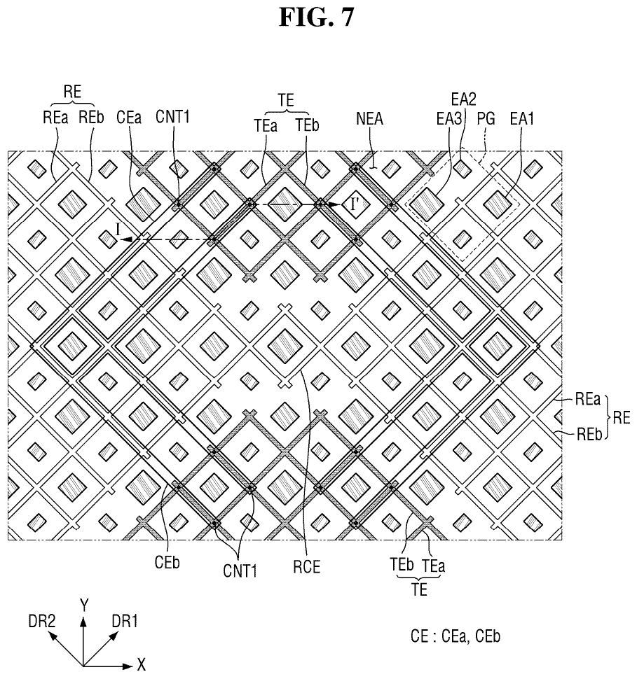

FIG. 6 is an enlarged view of area A1 of FIG. 5. FIG. 7 is an enlarged view showing a part of a display device according to an embodiment of the present disclosure.

Referring to FIGS. 6 and 7, the first electrodes TE may be arranged in the first direction X and in the second direction Y. The first electrodes TE may be spaced apart from one another in the first direction X and in the second direction Y. The first electrodes TE adjacent to one another in the second direction Y may be electrically connected through the bridge electrodes CE.

The second electrodes RE may extend in the first direction X and may be spaced apart from one another in the second direction Y. The second electrodes RE may be arranged in the first direction X and the second direction Y, and the second electrodes RE adjacent to one another in the first direction X may be electrically connected through connecting portions RCE. For example, the connecting portions RCE of the second electrodes RE may traverse between the first electrodes TE adjacent to each other.

The bridge electrodes CE may be disposed on a different layer from the first electrodes TE and the second electrodes RE. Each of the bridge electrodes CE may include a first portion CEa and a second portion CEb. For example, the second portion CEb of the bridge electrode CE may be connected to the first electrode TE disposed on a first side (a lower first electrode TE in FIG. 6) through a respective one of the first contact holes CNT1 and may extend in the direction DR2. The first portion CEa of the bridge electrode CE may extend at an angle from the second portion CEb. For example, the first portion CEa may be substantially perpendicular to the second portion CEb. The first portion CEa and the second portion CEb may meet at the second electrode RE (a left second electrode RE in FIG. 6). The first portion CEa may extend in a direction DR1, and may be connected to a first electrode TE disposed on a second side (an upper first electrode TE in FIG. 6) through a respective one of the first contact holes CNT1. As used herein, the direction DR1 may refer to the direction between the first direction X and the second direction Y, and the direction DR2 may refer to the direction crossing the direction DR1. For example, each of the plurality of bridge electrodes CE may connect between two of the first electrodes TE adjacent to each other in the second direction Y.

According to an embodiment of the present disclosure, the plurality of first electrodes TE, the plurality of second electrodes RE, and the plurality of dummy patterns DME (see FIG. 5) may be formed in a mesh or net pattern when viewed from above. The plurality of first electrodes TE, the plurality of second electrodes RE, and the plurality of dummy electrodes DME (see FIG. 5) may not overlap with the first to third emission areas EA1, EA2, and EA3 of the pixels PX. The plurality of bridge electrodes CE may not overlap with the first to third emission areas EA1, EA2 and EA3. Accordingly, the brightness of the light exiting from the emission areas EA1, EA2 and EA3 of the display device 10 may not be lowered by the touch unit TSU.

Each of the plurality of first electrodes TE may include a first portion TEa extended in the direction DR1 and a second portion TEb extended in the direction DR2. Each of the plurality of second electrodes RE may include a first portion REa extended in the direction DR1 and a second portion REb extended in the direction DR2.

According to another embodiment, the plurality of first electrodes TE, the plurality of second electrodes RE and the plurality of dummy patterns DME (see FIG. 5) may be formed as whole surfaces when viewed from above, instead of a mesh or net pattern. In this example, the plurality of first electrodes TE, the plurality of second electrodes RE and the plurality of dummy electrodes DME (see FIG. 5) may include a transparent conductive material having high light transmittance such as indium tin oxide (ITO) and indium zinc oxide (IZO).

The plurality of pixels PX may include first to third sub-pixels. The first to third sub-pixels may include the first to third light emission areas EA1, EA2, and EA3, respectively. For example, the first emission area EA1 may emit light of a first color or red light, the second emission area EA2 may emit light of a second color or green light, and the third emission area EA3 may emit light of a third color or blue light. It is, however, to be understood that the present disclosure is not limited thereto.

A single pixel PX may include a first emission area EA1, two second emission areas EA2 and a third emission area EA3 and may represent black-and-white/grayscale levels. Accordingly, black-and-white/grayscale levels may be represented by a combination of light emitted from the first emission area EA1, the two second emission areas EA2, and the third emission areas EA3.

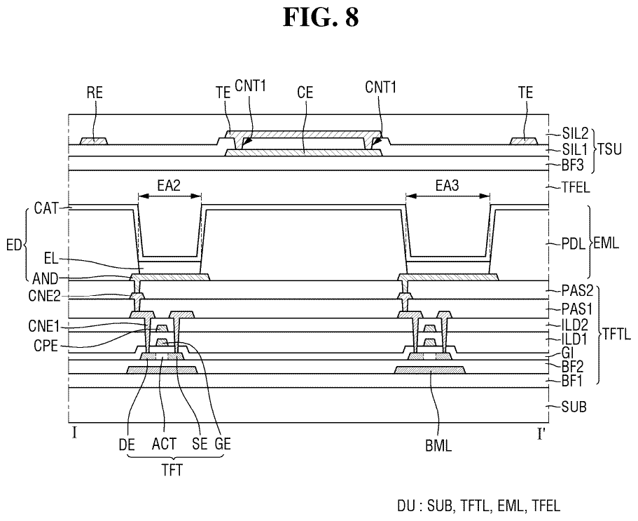

FIG. 8 is a cross-sectional view, taken along line I-I′ of FIG. 7.

Referring to FIG. 8, the display panel 100 (see FIG. 2) may include the display unit DU and the touch unit TSU. The display unit DU may include a substrate SUB, a thin-film transistor layer TFTL, an emission material layer EML, and an encapsulation layer TFEL.

The substrate SUB may support the display panel 100. The substrate SUB may be a base substrate or a base member, and may be made of an insulating material such as a polymer resin. For example, the substrate SUB may be a flexible substrate that can be bent, folded, or rolled. As another example, the substrate SUB may include a flexible material or a rigid material.

The thin-film transistor layer TFTL may be disposed on the substrate SUB. The thin-film transistor layer TFTL may include first and second buffer layers BF1 and BF2, thin-film transistors TFT, a gate insulator GI, a first interlayer dielectric film ILD1, capacitor electrodes CPE, a second interlayer dielectric film ILD2, first connection electrodes CNE1, a first passivation layer PAS1, second connection electrodes CNE2, and a second passivation layer PAS2.

The first buffer layer BF1 may be disposed on the substrate SUB. The first buffer layer BF1 may include an inorganic film capable of inhibiting or preventing permeation of air or moisture. For example, the first buffer layer BF1 may include a plurality of inorganic films stacked on one another.

The light-blocking layer BML may be disposed on the first buffer layer BF1. For example, the light-blocking layer BML may be include a single layer or multiple layers of molybdenum (Mo), aluminum (Al), chromium (Cr), gold (Au), titanium (Ti), nickel (Ni), neodymium (Nd), or copper (Cu), or an alloy thereof. For another example, the light-blocking layer BML may be an organic layer including a black pigment.

The second buffer layer BF2 may cover the first buffer layer BF1 and the light-blocking layer BML. The second buffer layer BF2 may include an inorganic film capable of inhibiting or preventing permeation of air or moisture. For example, the second buffer layer BF2 may include a plurality of inorganic films stacked on one another.

The thin-film transistor TFT may be disposed on the second buffer layer BF2 and may form a pixel circuit of the plurality of pixels. For example, the thin-film transistor TFT may be a driving transistor or a switching transistor of the pixel circuit. The thin-film transistor TFT may include a semiconductor region ACT, a gate electrode GE, a source electrode SE, and a drain electrode DE.

The semiconductor region ACT, the source electrode SE, and the drain electrode DE may be disposed on the second buffer layer BF2. The semiconductor region ACT may overlap the gate electrode GE in the thickness direction (e.g., the z-axis direction) and may be insulated from the gate electrode GE by the gate insulator GI. For example, the gate insulator GI may be disposed on the second buffer layer BF2. The source electrode SE and the drain electrode DE may be formed by converting the material of the semiconductor region ACT into a conductor.

The gate electrode GE may be disposed on the gate insulator GI. The gate electrode GE may overlap the semiconductor region ACT with the gate insulator GI interposed therebetween.

The gate insulator GI may be disposed on the semiconductor region ACT, the source electrode SE and the drain electrode DE. For example, the gate insulator GI may cover the semiconductor region ACT, the source electrode SE, the drain electrode DE, and the second buffer layer BF2. The gate insulator GI may insulate the semiconductor region ACT from the gate electrode GE. The gate insulator GI may include a contact hole through which the first connection electrode CNE1 passes.

The first interlayer dielectric layer ILD1 may cover the gate electrode GE and the gate insulator GI. The first interlayer dielectric layer ILD1 may include a contact hole through which the first connection electrode CNE1 may pass. The contact hole of the first interlayer dielectric layer ILD1 may be connected to the contact hole of the gate insulator GI and the contact hole of the second interlayer dielectric layer ILD2.

The capacitor electrode CPE may be disposed on the first interlayer dielectric layer ILD1. The capacitor electrode CPE may overlap with the gate electrode GE in the thickness direction (e.g., the z-axis direction).

The second interlayer dielectric film ILD2 may cover the capacitor electrode CPE and the first interlayer dielectric film ILD1. The second interlayer dielectric film ILD2 may include a contact hole through which the first connection electrode CNE1 may pass. The contact hole of the second interlayer dielectric film ILD2 may be connected to the contact hole of the first interlayer dielectric film ILD1 and the contact hole of the gate insulator GI.

The first connection electrode CNE1 may be disposed on the second interlayer dielectric film ILD2. The first connection electrode CNE1 may connect the drain electrode DE of the thin-film transistor TFT with the second connection electrode CNE2. The first connection electrode CNE1 may be disposed in a contact hole formed in the second interlayer dielectric layer ILD2, the first interlayer dielectric layer ILD1, and the gate insulator GI to be in contact with the drain electrode DE of the thin-film transistor TFT.

The first passivation layer PAS1 may cover the first connection electrode CNE1 and the second interlayer dielectric layer ILD2. The first passivation layer PAS1 may protect the thin-film transistor TFT. The first passivation layer PAS1 may include a contact hole through which the second connection electrode CNE2 passes.

The second connection electrode CNE2 may be disposed on the first passivation layer PAS1. The second connection electrode CNE2 may connect the first connection electrode CNE1 with a first electrode AND of a light-emitting diode ED. The second connection electrode CNE2 may be disposed in a contact hole formed in the first passivation layer PAS1 to be in contact with the first connection electrode CNE1.

The second passivation layer PAS2 may cover the second connection electrode CNE2 and the first passivation layer PAS1. The second passivation PAS2 may include a contact hole through which the first electrode AND of the light-emitting diode ED may pass.

The emission material layer EML may be disposed on the thin-film transistor layer TFTL. The emission material layer EML may include a light-emitting element ED and a pixel-defining layer PDL. The light-emitting diode ED may include a first electrode AND, an emissive layer EL, and a second electrode CAT.

The first electrode AND may be disposed on the second passivation layer PAS2. The first electrode AND may be disposed to overlap with an emission area of the first to third emission areas EA1, EA2, and EA3 defined by the pixel-defining film PDL. The first electrode AND may be connected to the drain electrode DE of the thin-film transistor TFT through the first and second connection electrodes CNE1 and CNE2.

The emissive layer EL may be disposed on the first electrode AND. For example, the emissive layer EL may be, but is not limited to, an organic emissive layer made of an organic material. In the case that the emissive layer EL is an organic emissive layer, when the thin-film transistor applies a predetermined voltage to the first electrode AND of the light-emitting diode ED and the second electrode CAT of the light-emitting diode ED receives a common voltage or cathode voltage, the holes and electrons may move to the organic emissive layer EL through the hole transporting layer and the electron transporting layer, respectively, and they combine in the organic layer E to emit light.

The second electrode CAT may be disposed on the emissive layer EL. For example, the second electrode CAT may be implemented as an electrode that commonly covers the pixels. The second electrode CAT may not be disposed as a separated electrode for each of the pixels. For example, the second electrode CAT may be disposed on the emissive layer EL in the first to third emission areas EA1, EA2 and EA3, and may be disposed on the pixel-defining layer PDL in the other areas than the first to third emission areas EA1, EA2 and EA3.

The pixel-defining film PDL may define first to third emission areas EA1, EA2, and EA3. The pixel-defining layer PDL may separate and insulate the first electrode AND of a light-emitting element of the plurality of light-emitting elements ED from the anode electrode of at least another one of the light-emitting elements ED.

The encapsulation layer TFEL may be disposed on the second electrode CAT to cover the light-emitting diodes ED. The encapsulation layer TFEL may include at least one inorganic layer to inhibit or prevent permeation of oxygen or moisture into the emission material layer EML. The encapsulation layer TFEL may include at least one organic layer to inhibit or protect the emission material layer EML from foreign substances such as dust.

The touch unit TSU may be disposed on the encapsulation layer TFEL. The touch unit TSU may include a third buffer layer BF3, a bridge electrode CE, a first insulating layer SIL1, a first electrode TE, a second electrode RE, and a second insulating layer SIL2.

The third buffer layer BF3 may be disposed on the encapsulation layer TFEL. The third buffer layer BF3 may be insulating and may have optical functions. The third buffer layer BF3 may include at least one inorganic layer. Optionally, the third buffer layer BF3 may be omitted.

The bridge electrode CE may be disposed on the third buffer layer BF3. The bridge electrode CE may be disposed in a different layer from the first electrodes TE and the second electrodes RE, and may connect between the first electrodes TE adjacent to each other in the second direction (e.g., the second direction Y in FIG. 7). For example, the bridge electrode CE may be made up of a single layer of molybdenum (Mo), titanium (Ti), copper (Cu), or aluminum (Al), or may be made up of a stack structure of aluminum and titanium (Ti/Al/Ti), a stack structure of aluminum and ITO (ITO/Al/ITO), an APC alloy and a stack structure of an APC alloy and ITO (ITO/APC/ITO).

The first insulating layer SIL1 may cover the bridge electrode CE and the third buffer layer BF3. The first insulating layer SIL1 may have insulating and optical functionalities. For example, the first insulating layer SIL1 may be formed of an inorganic layer, e.g., a silicon nitride layer, a silicon oxynitride layer, a silicon oxide layer, a titanium oxide layer, or an aluminum oxide layer.

The first electrodes TE and the second electrodes RE may be disposed on the first insulating layer SIL1. Each of the first electrodes TE and the second electrodes RE may be disposed away from the first to third emission areas EA1, EA2, and EA3 and may not overlap with the first to third emission areas EA1, EA2, and EA3. Each of the first electrodes TE and the second electrodes RE may be formed of a single layer of molybdenum (Mo), titanium (Ti), copper (Cu), or aluminum (Al), or may be made up of a stack structure of aluminum and titanium (Ti/Al/Ti), a stack structure of aluminum and ITO (ITO/Al/ITO), an APC alloy, or a stack structure of an APC alloy and ITO (ITO/APC/ITO).

The second insulating layer SIL2 may cover the first electrode TE, the second electrode RE and the first insulating layer SIL1. The second insulating layer SIL2 may have insulating and optical features. The second insulating layer SIL2 may be formed of an inorganic layer, e.g., a silicon nitride layer, a silicon oxynitride layer, a silicon oxide layer, a titanium oxide layer, or an aluminum oxide layer.

Although the bridge electrode CE may be formed in the layer under the first electrode TE and the second electrode RE in FIG. 8, the present disclosure is not limited thereto. For example, the bridge electrode CE may be formed in the layer above the first electrode TE and the second electrode RE.

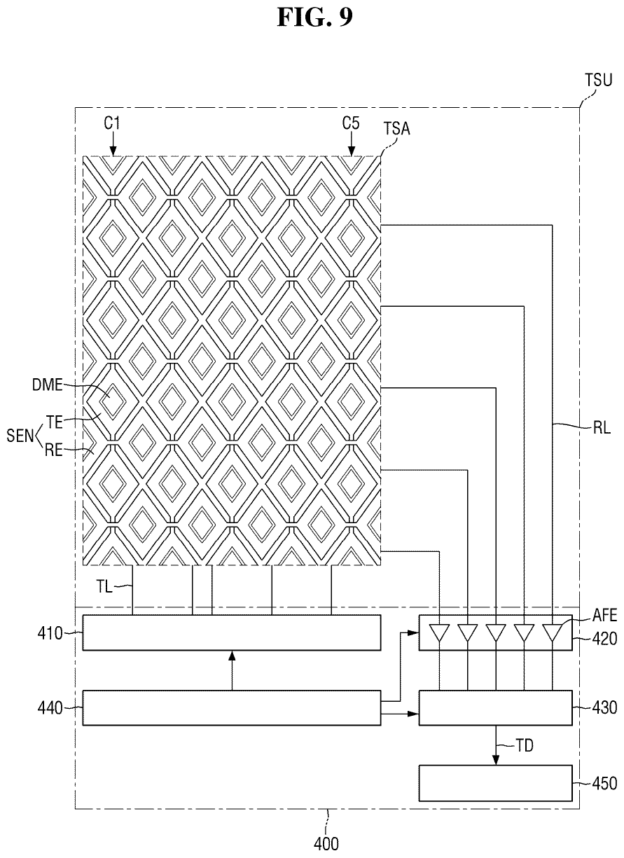

FIG. 9 is a block diagram showing a touch unit and a touch driver according to an embodiment of the present disclosure.

Referring to FIG. 9, the display device 10 may include a touch unit TSU and a touch driver circuit 400. The touch unit TSU shown in FIG. 9 is substantially identical to the touch unit TSU described with reference to FIGS. 2 to 8 and redundant descriptions thereof may be omitted.

The touch driver circuit 400 may include a driving signal output unit 410, a sensing circuit unit 420, an analog-to-digital conversion unit 430, a touch control unit 440, and a touch data compensation unit 450.

The driving signal output unit 410 may output driving signals to the first electrodes TE through the touch driving lines TL. The driving signals may be signals in the form of pulses.

The driving signal output unit 410 may output the driving signals to the touch driving lines TL in a predetermined order. For example, the driving signal output unit 410 may sequentially output the touch driving signals from the first electrodes TE disposed in the first column C1 at the leftmost position of the touch sensing area TSA to the first electrodes TE disposed in the fifth column C5 at the rightmost position of the touch sensing area TSA.

The sensing circuit unit 420 may be connected to the second electrodes RE through the sensing lines RL. The sensing circuit unit 420 may sense a change in the mutual capacitance of the touch nodes corresponding to the intersections of the first electrodes TE and the second electrodes RE through the sensing lines RL.

The sensing circuit unit 420 may include operational amplifiers AFE for sensing the amount of change in the mutual capacitance of the touch nodes. The operational amplifiers AFE may be connected to the sensing lines RL, respectively. The operational amplifiers AFE may amplify raw data input in the form of analog signals.

The analog-to-digital conversion unit 430 may convert each of the output voltages of the operational amplifiers AFE of the sensing circuit unit 420 into a detection signal TD, which is digital data.

The touch control unit 440 may control driving timings of the driving signal output unit 410, the sensing circuit unit 420, the analog-to-digital conversion unit 430, and the touch data compensation unit 450. The touch control unit 440 may output a timing signal for synchronizing the driving signal output unit 410, the sensing circuit unit 420, and the analog-to-digital conversion unit 430.

The touch data compensation unit 450 may receive the detection signal TD detected from the touch nodes in the touch sensing area TSA from the analog-to-digital conversion unit 430.

According to an embodiment, the driving signal output unit 410 of the touch driver circuit 400 may sequentially output driving signals in response to a vertical synchronization signal received from the touch control unit 440. The touch driver circuit 400 may calculate an elapsed time from a first time when the vertical synchronization signal is output to a second time when a detection signal is received. The touch driver circuit 400 may determine the touch coordinates of the touch based on the elapsed time.

According to an embodiment, the touch driver circuit 400 may transmit the elapsed time to a processor. The processor may determine the touch coordinates of the touch based on data corresponding to the elapsed time received from the touch driver circuit 400.

FIG. 10 is a plan view schematically showing a touch unit for self-capacitance sensing.

Referring to FIG. 10, the touch unit TSU according to an embodiment may include a plurality of self-capacitive touch electrodes TE. The plurality of self-capacitive touch electrodes TE may be arranged to overlap with a plurality of pixels (e.g., pixels PX of FIG. 4) of the display panel 100. Specifically, the self-capacitive touch electrodes TE may be arranged in a matrix, so that a touch input on the surface of the display device 10 of the display panel 100 can be sensed. For example, the size of the self-capacitive touch electrodes TE may be determined based on the contact area of a finger or the contact area of a pen.

The self-capacitive touch electrodes TE may be connected to the touch driver circuit 400 through a plurality of touch electrode lines TEL. Specifically, an end portion of each of the touch electrode lines TEL may be connected to a respective self-capacitive touch electrode TE, while an opposite end portion of each of the touch electrode lines TEL may be connected to the touch pads TP disposed in the touch peripheral area TPA.

Each of the plurality of self-capacitive touch electrodes TE may receive a driving signal. Each of the self-capacitive touch electrodes TE may form a predetermined capacitance with an electrode, a driving line, or a signal line of the display unit DU. When a touch input occurs on the plurality of self-capacitive touch electrodes TE, additional capacitance may be generated between the plurality of self-capacitive touch electrodes TE and an implement of the touch (e.g., a user's finger), and accordingly the capacitance of the plurality of self-touch electrodes TE may change. The sensing circuit unit 420 of the touch driver circuit 400 may sense a change in capacitance formed in each of the plurality of self-capacitive touch electrodes TE.

The touch driver circuit 400 may identify touch coordinates based on the time when a detection signal corresponding to a change in the capacitance formed in each of the self-capacitive touch electrodes TE is received. For example, the touch driver circuit 400 may determine an elapsed time from a first time when a vertical synchronization signal is output until the time when the detection signal is received, and may identify touch coordinates based on the counting results.

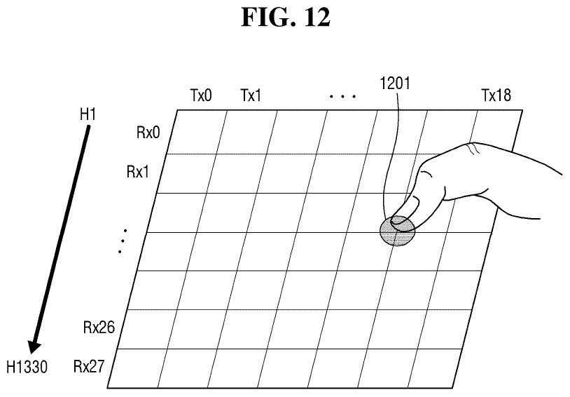

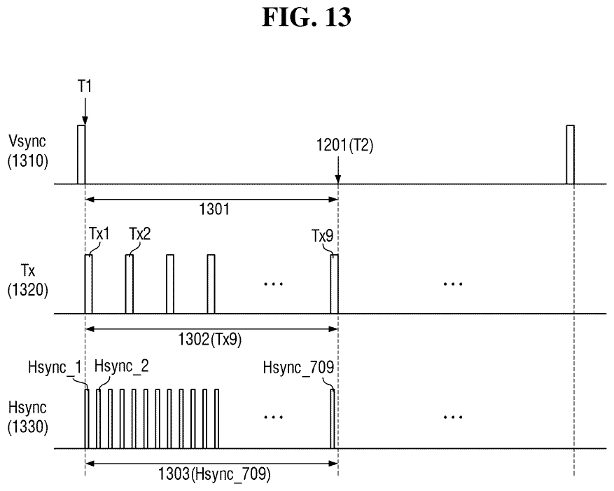

FIG. 11 is a flowchart illustrating operation of a display device according to an embodiment of the present disclosure. FIG. 12 is a view for illustrating a method for identifying a touch in a display device according to an embodiment of the present disclosure. FIG. 13 is a view for illustrating driving timing of a display device according to an embodiment.

In the graph of FIG. 13, a vertical synchronization signal 1310 that may be output in every frame. It may be assumed that a user is touching the touch unit TSU of the display panel 100 at or before a first time T1 (e.g. time T1 of FIG. 13) at which the vertical synchronization signal 1310 is output.

In the graph of FIG. 13, driving signals 1320 may be sequentially output to a plurality of touch driving electrodes (e.g., the first electrodes TE of FIG. 9) in response to the vertical synchronization signal 1310.

In the graph of FIG. 13, a horizontal synchronization signal may be sequentially output in each frame.

Hereinafter, an operation of a display device 10 according to an embodiment of the present disclosure will be described in detail with reference to FIGS. 10 to 13. Operations described below may be performed under the control of a touch driver circuit 400. Alternatively, the operations described below may be performed under the control of a host 500. In the following description, the element that controls each of the operations will be described as the touch driver circuit 400 for convenience of illustration. It should be understood, however, that each of the operations may be performed by the host 500, or another processor.

In operation 1110, the touch driver circuit 400 may sequentially output driving signals to a plurality of touch driving electrodes (e.g., the first electrodes TE of FIG. 9) in response to a vertical synchronization signal 1310. For example, as shown in FIG. 12, the touch driver circuit 400 may sequentially output driving signals from a touch driving electrode Tx0 disposed at a leftmost position to a touch driving electrode Tx18 disposed at a rightmost position after the first time T1 (e.g. time T1 of FIG. 13) at which the vertical synchronization signal 1310 is output.

In operation 1120, the touch driver circuit 400 may receive a detection signal. The touch driver circuit 400 may sense, as a detection signal, a change in a mutual capacitance of touch nodes corresponding to the intersections of the touch driving electrodes (e.g., the first electrodes TE of FIG. 9) and the touch sensing electrodes (e.g., the second electrodes RE in FIG. 9) via sensing lines (e.g. the sensing lines RL of FIG. 9). For example, the touch driver circuit 400 may sense, as a detection signal, an amount of change in the mutual capacitance.

In operation 1130, the touch driver circuit 400 or a processor may calculate an elapsed time (e.g. time 1301 of FIG. 13) measured from the first time T1 at which the vertical synchronization signal 1310 is output until the second time at which the detection signal is received (e.g., time T2 of FIG. 13). For example, as shown in FIG. 12, the touch unit TSU may include touch driving electrodes Tx0 to Tx18, which may extend in the vertical direction and be spaced apart from each other in the horizontal direction. In addition, the touch unit TSU may include touch sensing electrodes Rx0 to Rx27, which may extend in the horizontal direction and may be spaced apart from each other in the vertical direction. For example, the touch sensing electrodes Rx0 to Rx27 of the touch unit TSU may correspond to 27 channels among the first channel H1 to the 1330^{th} channel H1330 through which the horizontal synchronization signal is output.

For example, a user may touch the touch unit TSU of the display panel 100, and in a case that the user touches a particular touch node 1201 where the touch driving electrode Tx9 and a touch sensing electrode intersect each other, the detection signal corresponding to the change in the capacitance generated from the particular touch node 1201 may be input to the touch driver circuit 400. The touch driver circuit 400 may calculate the elapsed time 1301 measured from the first time T1 when the vertical synchronization signal 1310 is output until the detection signal for the touch node 1201 is received. For example, as shown in FIG. 13, the elapsed time 1301 may correspond to a first counting time 1302 taken for the touch driver circuit 400 to sequentially output driving signals from the touch driving electrode Tx1 to the touch driving electrode Tx9. In addition, as the horizontal synchronization signal may be sequentially output from the first channel H1 to the 1330^{th} channel H1330, the elapsed time 1301 may correspond to a second counting time 1303 taken to output the first horizontal synchronization signal Hsync_1 to the 709^{th} horizontal synchronization signal Hsync_709.

In operation 1140, the touch driver circuit 400 or the host 500 may determine touch coordinates based on the calculated elapsed time 1301. For example, the touch driver circuit 400 may determine the x coordinate of the touch coordinates based on the first counting time 1302. In addition, the touch driver circuit 400 may determine the y coordinate of the touch coordinates based on the second counting time 1303. In this way, when the detection signal is sensed, the touch driver circuit 400 may determine the time when the detection signal was received, and may determine the x coordinate and the y coordinates of the touch coordinates based on the determined time. At this time, the touch driver circuit 400 may calculate the x coordinate of the touch coordinates by storing the time when the driving signals are sequentially output to a plurality of touch driving electrodes (e.g., the first electrodes TE of FIG. 9) measured from the first time T1 when the vertical synchronization signal 1310 is output. In addition, the touch driver circuit 400 may calculate the y coordinate of the touch coordinates by storing the time when horizontal synchronization signals are sequentially output measured from the first time T1 when the vertical synchronization signal 1310 is output.

According to some embodiments, the vertical synchronization signal Vsync and the horizontal synchronization signal Hsync output by the host 500 (see FIG. 3) may be used for touch sensing. For example, the vertical synchronization signal Vsync and the horizontal synchronization signal Hsync output by the host 500 may be received by the touch driver circuit400.

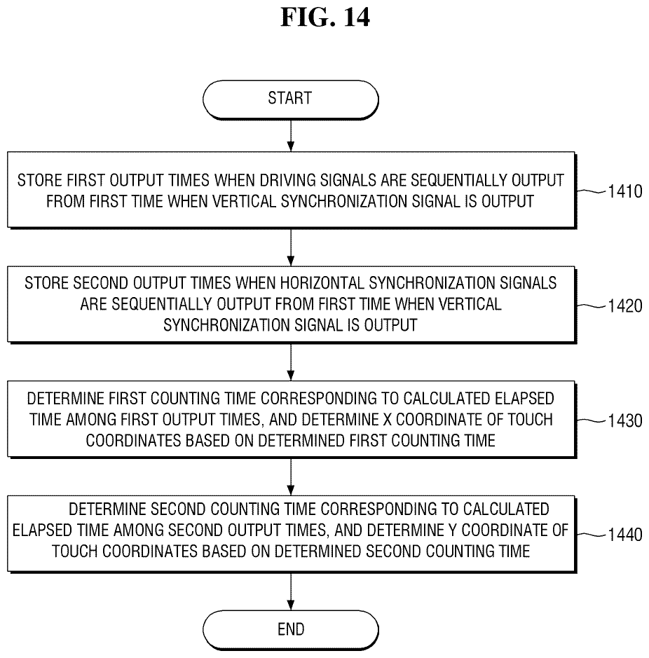

FIG. 14 is a flowchart illustrating a method for identifying touch coordinates using the touch unit shown in FIGS. 5 to 9.

Operations described herein may be performed under the control of a touch driver circuit 400. Alternatively, the operations described below may be performed under the control of a host 500. In the following description, the element that controls each of the operations will be described as the touch control unit 440 for convenience of illustration. It should be understood, however, that each of the operations may be performed by the host 500, or another processor. Further, it should be understood that the touch driver circuit 400 or the host 500 may include a memory (not shown) for storing data.

In operation 1410, the touch driver circuit 400 or the host 500 may store a plurality of first output times until the driving signals are sequentially output, measured from the first time T1 at which the vertical synchronization signal 1310 is output. For example, the touch driver circuit 400 may store the time from the first time T1 when the vertical synchronization signal 1310 is output until the driving signal is output to the touch driving electrode Tx1. In addition, the touch driver circuit 400 may store the time from the first time T1 when the vertical synchronization signal 1310 is output until the driving signal is output to the touch driving electrode Tx2. In addition, the touch driver circuit 400 may store the time from the first time T1 when the vertical synchronization signal 1310 is output until the driving signal is output to the touch driving electrode Tx3. In this manner, the touch driver circuit 400 may store the times until the driving signals are output to the touch driving electrodes, respectively, with respect to the first time T1 when the vertical synchronization signal 1310 is output.

In operation 1420, the touch driver circuit 400 or a processor may store a plurality of second output times until horizontal synchronization signals are sequentially output, measured from the first time T1 at which the vertical synchronization signal 1310 is output. For example, the touch driver circuit 400 may store the time from the first time T1 when the vertical synchronization signal 1310 is output until a first horizontal synchronization signal is output. In addition, the touch driver circuit 400 may store the time from the first time T1 when the vertical synchronization signal 1310 is output until a second horizontal synchronization signal is output. In addition, the touch driver circuit 400 may store the time from the first time T1 when the vertical synchronization signal 1310 is output until a third horizontal synchronization signal is output. In this manner, the touch driver circuit 400 may store the times until the horizontal synchronization signals are output, respectively, with respect to the first time T1 when the vertical synchronization signal 1310 is output.

In operation 1430, the touch driver circuit 400 or the host 500 may calculate the elapsed time 1301 from the first time T1 when the vertical synchronization signal 1310 is output until the detection signal is received. The touch driver circuit 400 determines a first counting time 1302 corresponding to the calculated elapsed time 1301 among the plurality of first output times, and determines the x coordinate of the touch coordinates based on the determined first counting time 1302. For example, as shown in FIG. 13, the touch driver circuit 400 may check that the first counting time 1302 is the time for outputting a driving signal to the touch driving electrode Tx9, and may determine that the x coordinate of the touch coordinates is located such that it corresponds to the touch driving electrode Tx9.

In operation 1440, the touch driver circuit 400 or the host 500 may calculate the elapsed time 1301 from the first time T1 when the vertical synchronization signal 1310 is output until the detection signal is received. The touch driver circuit 400 may determine a second counting time 1303 corresponding to the calculated elapsed time 1301 among the plurality of first output times, and determines the y coordinate of the touch coordinates based on the determined second counting time 1303. For example, as shown in FIG. 13, the touch driver circuit 400 may check that the second counting time 1303 is the time for outputting the 709^{th} horizontal synchronization signal Hsync_709, and may determine that the y coordinate of the touch coordinates is located such that it corresponds to a particular channel (or a particular touch sensing electrode) through which the 709^{th} horizontal synchronization signal Hsync_709 is output.

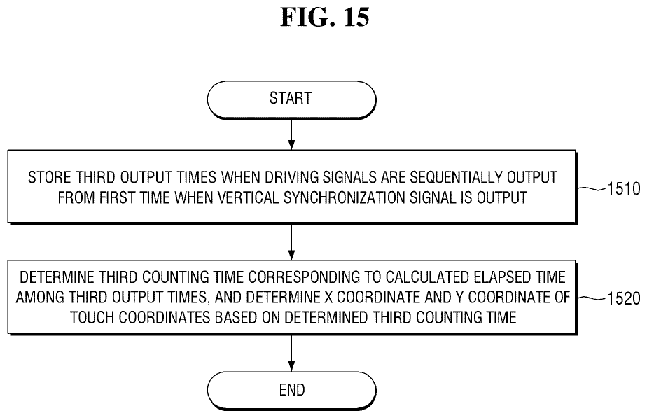

FIG. 15 is a flowchart illustrating a method for identifying touch coordinates using the touch unit shown in FIG. 10.

Operations described below may be performed under the control of a touch driver circuit 400. Alternatively, the operations described below may be performed under the control of a processor. In the following description, the element that controls each of the operations will be described as the touch driver circuit 400 for convenience of illustration. It should be understood, however, that each of the operations may be performed by the host 500, or another processor.

In operation 1510, the touch driver circuit 400 or a processor may store a plurality of third output times until the driving signals are sequentially output, measured from the first time T1 at which the vertical synchronization signal 1310 is output. For example, the touch unit TSU may include a plurality of self-capacitive touch electrodes TE arranged in a matrix, as shown in FIG. 10, and driving signals may be sequentially supplied to the plurality of self-capacitive touch electrodes TE. For example, the touch driver circuit 400 may store the times until the driving signal is output to each of the self-capacitive touch electrodes TE from the first time T1 when the vertical synchronization signal 1310 is output.

In operation 1520, the touch driver circuit 400 or a processor may calculate the elapsed time 1301 from the first time T1 when the vertical synchronization signal 1310 is output until the detection signal is received. The touch driver circuit 400 may determine a third counting time corresponding to the calculated elapsed time 1301 among the plurality of third output times, and may determine the x coordinate and y coordinate of the touch coordinates based on the determined third counting time.

In this way, when the detection signal is sensed (e.g., due to a touch input), the touch driver circuit 400 or the host 500 may check the time when the detection signal was received, and may determine the x coordinate and the y coordinate of the touch coordinates based on the checked time. At this time, the touch driver circuit 400 may calculate the x coordinate and the y coordinate of the touch coordinates by storing the time when the driving signals are sequentially output to each of the plurality of self-capacitive touch electrodes from the first time T1 when the vertical synchronization signal 1310 is output.

As described herein, according to exemplary embodiments, the calculation time and power consumption to identify touch coordinates may be reduced in a display device, and a flicker condition of the display panel due to driving of the touch panel may be reduced.

In concluding the detailed description, those skilled in the art will appreciate that many variations and modifications can be made to embodiments without substantially departing from the principles of the present invention. Therefore, disclosed embodiments of the invention are used in a generic and descriptive sense only and not for purposes of limitation.

What is claimed is:

1. A display device comprising:
a display panel comprising touch driving electrodes; and
a touch driver circuit comprising a driving signal output unit configured to output driving signals supplied to the touch driving electrodes, and a touch control unit configured to control the driving signal output unit,
wherein the touch driver circuit is configured to:
sequentially output the driving signals in response to a vertical synchronization signal;
receive a detection signal associated with a touch input on the display panel;
calculate an elapsed time from a first time when the vertical synchronization signal is output until a second time when the detection signal is received; and
determine touch coordinates of the touch input based on the elapsed time.

2. The display device of claim 1, wherein the display panel further comprises touch sensing electrodes disposed intersecting with the touch driving electrodes, and
wherein the touch driver circuit receives the detection signal through the touch sensing electrodes.

3. The display device of claim 2, wherein the touch driver circuit is further configured to:
store a plurality of first output times until the driving signals are sequentially output measured from the first time;
store a plurality of second output times until horizontal synchronization signals of the display panel are sequentially output measured from the first time;
determine a first counting time corresponding to the elapsed time among the plurality of first output times, to determine an x coordinate of the touch coordinates based on the first counting time; and
determine a second counting time corresponding to the elapsed time among the plurality of second output times, to determine a y coordinate of the touch coordinates based on the second counting time.

4. The display device of claim 3, wherein the touch driver circuit transmits the x coordinate and the y coordinate of the touch coordinates to a host of the display device.

5. The display device of claim 4, wherein the host is a processor.

6. The display device of claim 1, wherein the touch driving electrodes are self-capacitive touch electrodes arranged in a matrix.

7. The display device of claim 6, wherein the touch driver circuit stores a plurality of third output times until driving signals are sequentially output measured from the first time, and determines a third counting time corresponding to the elapsed time among the plurality of third output times, to determine an x coordinate and a y coordinate of the touch coordinates based on the third counting time.

8. A display device comprising:
a host;
a display panel comprising touch driving electrodes; and
a touch driver circuit comprising a driving signal output unit configured to output driving signals supplied to the touch driving electrodes, and a touch control unit configured to control the driving signal output unit,
wherein the touch driver circuit is configured to:
sequentially output the driving signals in response to a vertical synchronization signal of the display panel;
receive a detection signal associated with a touch input on the display panel; and
transmit an elapsed time until a second time when the detection signal is received measured from a first time when the vertical synchronization signal is output by the host of the display device, and
wherein the host determines touch coordinates of the touch input based on the elapsed time received from the touch driver circuit.

9. The display device of claim 8, wherein the host is a processor.

10. The display device of claim 8, wherein the display panel further comprises touch sensing electrodes disposed intersecting with the touch driving electrodes, and
wherein the touch driver circuit receives the detection signal through the touch sensing electrodes.

11. The display device of claim 10, wherein the host is configured to:
store a plurality of first output times until the driving signals are sequentially output measured from the first time;
store a plurality of second output times until horizontal synchronization signals of the display panel are sequentially output measured from the first time;
determine a first counting time corresponding to an elapsed time among the plurality of first output times, to determine an x coordinate of the touch coordinates based on the first counting time; and
determine a second counting time corresponding to an elapsed time among the plurality of second output times, to determine a y coordinate of the touch coordinates based on the second counting time.

12. The display device of claim 8, wherein the touch driving electrodes are self-capacitive touch electrodes arranged in a matrix.

13. The display device of claim 12, wherein the host stores a plurality of third output times until driving signals are sequentially output measured from the first time, and determines a third counting time corresponding to an elapsed time of the plurality of third output times, to determine an x coordinate and a y coordinate of the touch coordinates based on the third counting time.

14. A method for driving a display device, wherein the display device comprises a display panel that comprises touch driving electrodes, and a touch driver circuit configured to output driving signals supplied to the touch driving electrodes, the method comprising:
outputting, sequentially, by the touch driver circuit, the driving signals in response to a vertical synchronization signal of the display panel;
receiving, by the touch driver circuit, a detection signal associated with a touch input on the display panel;
calculating, by the touch driver circuit, an elapsed time until a second time when the detection signal is received measured from a first time when the vertical synchronization signal is output; and
determining, by the touch driver circuit, touch coordinates of the touch input based on the elapsed time.

15. The method of claim 14, wherein the display panel further comprises touch sensing electrodes disposed intersecting with the touch driving electrodes, and
wherein the method further comprises receiving, by the touch driver circuit, the detection signal through the touch sensing electrodes.

16. The method of claim 15, further comprising:
storing, by the touch driver circuit, a plurality of first output times until the driving signals are sequentially output measured from the first time;
storing, by the touch driver circuit, a plurality of second output times until horizontal synchronization signals of the display panel are sequentially output measured from the first time;
determining, by the touch driver circuit, a first counting time corresponding to an elapsed time among the plurality of first output times, to determine an x coordinate of the touch coordinates based on the first counting time; and
determining, by the touch driver circuit, a second counting time corresponding to an elapsed time among the plurality of second output times, to determine a y coordinate of the touch coordinates based on the second counting time.

17. The method of claim 16, further comprising:
transmitting, by the touch driver circuit, the x coordinate and the y coordinate of the touch coordinates to a host of the display device.

18. The method of claim 17, wherein the host is a processor.

19. The method of claim 18, wherein the touch driving electrodes are self-capacitive touch electrodes arranged in a matrix, wherein the method further comprises:
storing, by the touch driver circuit, a plurality of third output times until driving signals are sequentially output measured from the first time; and
determining, by the touch driver circuit, a third counting time corresponding to the calculated elapsed time among the plurality of third output times, to determine the x coordinate and the y coordinate of the touch coordinates based on the third counting time.

20. The method of claim 19, further comprising receiving the touch input on the display panel prior to the first time.
